(19) United States
(12) Patent Application Publication
(10) Pub. No.: US 2025/0261240 A1
(43) Pub. Date: Aug. 14, 2025

(54) SYSTEMS AND METHODS FOR RELAXED PROCESSING TIME FOR REDCAP DEVICES

(71) Applicant: Intel Corporation, Santa Clara, CA (US)

(72) Inventors: Yingyang Li, Santa Clara, CA (US); Yi Wang, Santa Clara, CA (US); Gang Xiong, Portland, OR (US); Debdeep Chatterjee, San Jose, CA (US); Toufiqul Islam, Santa Clara, CA (US)

(21) Appl. No.: 18/849,253

(22) PCT Filed: Jun. 21, 2023
(86) PCT No.: PCT/US2023/068791

§ 371 Date: Sep. 20, 2024

Related U.S. Application Data
(60) Provisional application No. 63/354,643, filed on Jun. 22, 2022.
(60) Provisional application No. 63/483,687, filed on Feb. 7, 2023.

(51) Int. Cl. H04W 74/0833; H04L 27/26; H04W 8/22; H04W 72/0446

(52) U.S. Cl. CPC H04W 74/0833; H04L 27/26025; H04L 27/261; H04W 72/0446; H04W 8/22

(57) ABSTRACT

Various embodiments herein provide techniques for reduced capability (RedCap) user equipments (UEs). For example, embodiments relate to a relaxed (longer) timeline requirement associated with a random access procedure and/or other communications of RedCap UEs. The techniques may support existing RedCap use cases, as well as extend RedCap UEs to new use cases. Other embodiments may be described and claimed.

### CROSS REFERENCE TO RELATED APPLICATION

The present application claims priority to U.S. Provisional Patent Application No. 63/354,643, which was filed Jun. 22, 2022; and to U.S. Provisional Patent Application No. 63/483,687, which was filed Feb. 7, 2023.

### FIELD

Various embodiments generally may relate to the field of wireless communications. For example, some embodiments may relate to techniques for reduced capability (RedCap) user equipments (UEs).

### BACKGROUND

The Third Generation Partnership Project (3GPP) Fifth Generation (5G) New Radio (NR) specifications cater to support of a diverse set of verticals and use cases, including enhanced mobile broadband (eMBB) as well as the newly introduced ultra reliable and low latency communication (URLLC) services. Support for Low Power Wide Area (LPWA) networks and use cases for extremely low complexity/cost devices, targeting extreme coverage and ultra-long battery lifetimes, are expected to be served by machine-type communication (MTC) (Category M user equipments (UEs)) and narrow band (NB)-Internet of things (IoT) (Category NB UEs) technologies.

Through the Rel-17 NR reduced capability (RedCap) work item, 3GPP has established a framework for enabling reduced capability NR devices suitable for a range of use cases, including the industrial sensors, video surveillance, and wearables use cases, with requirements on low UE complexity and sometimes also on low UE power consumption.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a wireless network in accordance with various embodiments.

FIG. 2 schematically illustrates components of a wireless network in accordance with various embodiments.

FIG. 3 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 4 and 5 illustrate example procedures to practice various embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Embodiments herein provide techniques for reduced capability (RedCap) user equipments (UEs) which may further reduce complexity for RedCap UEs. The embodiments may improve support for the previously identified use cases and also expand RedCap into a new range of use cases such as smart grid. For example, the embodiments may further expand the market for RedCap use cases with relatively low cost, low energy consumption, and low data rate requirements, e.g., industrial wireless sensor network use cases. Aspects of the embodiments may be adopted into 3GPP Rel-18 specifications for enhanced RedCap UE (eRedCap UE).

In the existing NR specification, the PDSCH processing time for PDSCH processing time capability 1, PUSCH preparation time for PUSCH timing capability 1 and CSI computation delay requirement 2 are specified in the following tables from 3GPP TS 38.214, V17.1.0 (hereinafter “TS 38.214”).

TABLE 5.3-1
PDSCH processing time for PDSCH processing capability 1

| | PDSCH decoding time N₁ [symbols] | |
|---|---|---|
| | dmrs-AdditionalPosition = ‘pos0’ in | |
| | DMRS-DownlinkConfig in | dmrs-AdditionalPosition ≠ ‘pos0’ in |
| | dmrs-DownlinkForPDSCH- | DMRS-DownlinkConfig in any of |
| | MappingTypeA and dmrs- | dmrs-DownlinkForPDSCH- |
| | DownlinkForPDSCH- | MappingTypeA, dmrs- |
| | MappingTypeB if either higher | DownlinkForPDSCH- |
| | layer parameter is configured, and | MappingTypeB, dmrs- |
| | in dmrs-DownlinkForPDSCH- | DownlinkForPDSCH- |
| | MappingTypeA-DCI-1-2 and dmrs- | MappingTypeA-DCI-1-2, dmrs- |
| | DownlinkForPDSCH- | DownlinkForPDSCH- |
| | MappingTypeB-DCI-1-2 if either | MappingTypeB-DCI-1-2, |
| | higher layer parameter is | or if none of the higher layer |
| μ | configured | parameters is configured |
| 0 | 8 | N_{1, 0} |
| 1 | 10 | 13 |
| 2 | 17 | 20 |
| 3 | 20 | 24 |
| 5 | 80 | 96 |
| 6 | 160 | 192 |

TABLE 6.4-1
PUSCH preparation time for PUSCH timing capability 1

| | PUSCH preparation time N₂ |
|---|---|
| μ | [symbols] |
| 0 | 10 |
| 1 | 12 |
| 2 | 23 |
| 3 | 36 |
| 5 | 144 |
| 6 | 288 |

TABLE 5.4-2
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + | X₂ |
| | | | | | KB₁) | |
| 3 | 97 | 85 | 152 | 140 | min(97, X₃ + | X₃ |
| | | | | | KB₂) | |
| 5 | 388 | 340 | 608 | 560 | min(388, X5 + | X5 |
| | | | | | KB3) | |
| 6 | 776 | 680 | 1216 | 1120 | min(776, X6 + | X6 |
| | | | | | KB4 | |

One potential enhancement in accordance with various embodiments herein is to relax the processing time for eRedCap UEs. For example, the above processing time indicated above may be doubled or otherwise increased for eRedCap UEs. The extended processing time may enable reduced UE complexity by allowing a longer time for the processing of PDSCH, preparing PUSCH or performing CSI measurement and report, among other operations. Various embodiments herein provide techniques related to relaxed processing time for eRedCap UEs, such as:
Relaxed PDSCH processing time;
Relaxed scheduling delay; and/or
Relaxed CSI computation delay.

Relaxing the processing time for a UE can potentially reduce the UE complexity by allowing a longer time for the processing of PDSCH, preparing PUSCH or performing CSI measurement and report. Various other aspects of the UE will be impacted by the relaxing of PDSCH processing time, PUSCH preparation time and CSI computation delay.

It is noted that while multiple embodiments and examples are provided in the subsequent sub-sections based on a multiplicative scaling, by a factor greater than one, of existing processing minimum UE processing times to relax the timelines, similar time-line relaxations may also be realized by other means, such as with suitable choices of additive factors to the currently specified minimum UE processing times.

### Relaxed PDSCH Processing Time (N1)

According to section 5.3, TS38.214 in NR, if the first uplink symbol of the PUCCH which carries the HARQ-ACK information, as defined by the assigned HARQ-ACK timing K₁ and K_{offset}, if configured, and the PUCCH resource to be used and including the effect of the timing advance, starts no earlier than at symbol L₁, where L₁ is defined as the next uplink symbol with its CP starting after T_{proc,1}=(N₁+d_{1,1}+d₂) (2048+144)·κ2^{-μ}·T_{C}+Tₑₓₜ after the end of the last symbol of the PDSCH carrying the TB being acknowledged, then the UE shall provide a valid HARQ-ACK message.

The UE complexity can be reduced by increasing the PDSCH processing time (N1) by a scaling factor c. The value c can be predefined or reported by a UE capability. For example, c equals to 2. Note: the new N1 values after scaling may be directly specified in the specification instead of specifying value c. Corresponding to the increase of PDSCH processing time, some other parameters may be increased too. The increase of processing time may be only applied if processingType2Enabled of PDSCH-ServingCellConfig is set to disable for a serving cell.

In one embodiment, the values of d_{1,1} and/or d₂ in the formula to determine T_{proc,1} can be increased in accordance with the increase of N1.

In one option, the values of d_{1,1} and/or d₂ in the formula to determine T_{proc,1} can be increased by a scaling factor c₀. The value c₀ can be predefined or reported by a UE capability. Note: the new d_{1,1} and/or d₂ values after scaling may be directly specified in the specification instead of specifying value c₀.

In another option, for eRedCap UE, the value of N1 may be increased while the values of d_{1,1} and/or d₂ in the formula to determine T_{proc,1} may be same as specified in Rel-15 NR specifications.

In one embodiment, the value range of PDSCH-to-HARQ_feedback slot offset (K1) can be increased in accordance with the increase of N1.

In one option, for DCI format 1_1 or 1_2, the value range of K1 can be changed to from X to Y. In one example, X>0, and Y is same as Rel-15, e.g., Y=15. In another example, X=0 and Y can be increased to 16c₁−1. In another example, X>0 and Y can be increased to 16c₁−1. The value c₁ can be predefined or reported by a UE capability.

In another option, for DCI format 1_1 if unlicensed operation is supported, the value range of K1 may be increased to from −1 to 16c₁−1. The value c₁ can be predefined or reported by a UE capability.

Note: the new range of K1 after scaling may be directly specified in the specification instead of specifying value c₁.

In another option, for DCI format 1_0, the candidate values of K1 may be {c₁, 2c₁, 3c₁, 4c₁, 5c₁, 6c₁, 7c₁, 8c₁}. The value c₁ can be predefined or reported by a UE capability. Note: the new values K1 may be directly specified in the specification instead of specifying value c₁.

In another option, for DCI format 1_1 or 1_2, the value range of K1 for DCI format 1_1 or 1_2 may be not changed for eRedCap UE. Consequently, it is up to gNB implementation to not configure or indicate a value of K1 which results in short of PDSCH processing time.

In another option, for DCI format 1_0, the candidate values of K1 may be not changed for eRedCap UE, e.g., {1,2,3,4,5,6,7,8}. Consequently, it is up to gNB implementation to not indicate a value of K1 which results in short of PDSCH processing time.

In another option, for the set of values for HARQ Feedback Timing Indicator field in successRAR, the candidate values of K1 may be {c₁, 2c₁, 3c₁, 4c₁, 5c₁, 6c₁, 7c₁, 8c₁}. The value c₁ can be predefined or reported by a UE capability. Note: the new values K1 may be directly specified in the specification instead of specifying value c₁.

In another option, for the set of values for HARQ Feedback Timing Indicator field in successRAR, the candidate values of K1 may be not changed for eRedCap UE, e.g., {1,2,3,4,5,6,7,8}. Consequently, it is up to gNB implementation to not indicate a value of K1 which results in short of PDSCH processing time.

In one embodiment, the value N₃ of HARQ-ACK multiplexing timeline can be increased in accordance with the increase of N1.

In section 9.2.3, TS38.213, V17.1.0 (hereinafter “TS38.213”) in NR, if a UE determines a first resource for a PUCCH transmission with HARQ-ACK information corresponding only to a PDSCH reception without a corresponding PDCCH or detects a first DCI format indicating a first resource for a PUCCH transmission with corresponding HARQ-ACK information in a slot and also detects at a later time a second DCI format indicating a second resource for a PUCCH transmission with corresponding HARQ-ACK information in the slot, the UE does not expect to multiplex HARQ-ACK information corresponding to the second DCI format in a PUCCH resource in the slot if the PDCCH reception that includes the second DCI format is not earlier than N₃·(2048+144)·κ·2^{-μ}·T_{c} from the beginning of a first symbol of the first resource for PUCCH transmission in the slot where, κ and T_{c} are defined in clause 4.1 of [4, TS 38.211] and μ corresponds to the smallest SCS configuration among the SCS configurations of the PDCCHs providing the DCI formats and the SCS configuration of the PUCCH. If processingType2Enabled of PDSCH-ServingCellConfig is set to enable for the serving cell with the second DCI format and for all serving cells with corresponding HARQ-ACK information multiplexed in the PUCCH transmission in the slot, N₃=3 for μ=0, N₃=4.5 for μ=1, N₃=9 for μ=2; otherwise, N₃=8 for μ=0, N₃=10 for μ=1, N₃=17 for μ=2, N₃=20 for μ=3, N₃=80 for μ=5, and N₃=160 for μ=6.

In one option, the above value N₃ of HARQ-ACK multiplexing timeline may be increased by scaling factor c₂. The value c₂ can be predefined or reported by a UE capability. Note: the new values N3 may be directly specified in the specification instead of specifying value c₂. For example, for eRedCap, N₃=16 for μ=0, N₃=20 for μ=1, N₃=34 for μ=2 if applicable.

In one embodiment, the value N of HARQ-ACK feedback timeline for SPS PDSCH release can be increased in accordance with the increase of N1.

In section 10.2, TS38.213 in NR, a UE is expected to provide HARQ-ACK information in response to a SPS PDSCH release after N symbols from the last symbol of a PDCCH providing the SPS PDSCH release. If processingType2Enabled of PDSCH-ServingCellConfig is set to enable for the serving cell with the PDCCH providing the SPS PDSCH release, N=5 for μ=0, N=5.5 for μ=1, and N=11 for μ=2, otherwise, N=10 for μ=0, N=12 for μ=1, N=22 for μ=2, N=25 for μ=3, N=100 for μ=5, and N=200 for μ=6, wherein u corresponds to the smallest SCS configuration between the SCS configuration of the PDCCH providing the SPS PDSCH release and the SCS configuration of a PUCCH carrying the HARQ-ACK information in response to a SPS PDSCH release.

In one option, the above value N of HARQ-ACK feedback timeline for SPS PDSCH release may be increased by scaling factor c₃. The value c₃ can be predefined or reported by a UE capability. Note: the new values N may be directly specified in the specification instead of specifying value c₃. For example, for eRedCap, N₃=20 for μ=0, N₃=24 for μ=1, N₃=44 for μ=2 if applicable.

In the above embodiments, the scaling factors c₀, c₁, c₂, c₃ may be equal to c respectively. Alternatively, the scaling factors c₀, c₁, c₂, c₃ may be different from c.

### Relaxed Scheduling Delay

According to section 6.4, TS38.214 in NR, If the first uplink symbol in the PUSCH allocation for a transport block, including the DM-RS, as defined by the slot offset K₂ and K_{offset}, if configured, and the start S and length L of the PUSCH allocation indicated by ‘Time domain resource assignment’ of the scheduling DCI and including the effect of the timing advance, is no earlier than at symbol L₂, where L₂ is defined as the next uplink symbol with its CP starting T_{proc,2}=max((N₂+d_{2,1}+d₂) (2048+144)·κ2^{-μ}·T_{C}+Tₑₓₜ+T_{switch}, d_{2,2}) after the end of the reception of the last symbol of the PDCCH carrying the DCI scheduling the PUSCH, then the UE shall transmit the transport block. When the PDCCH reception includes two PDCCH candidates from two respective search space sets, as described in clause 10.1 of [6, TS 38.213], for the purpose of determining the last symbol of the PDCCH carrying the DCI scheduling the PUSCH, the PDCCH candidate that ends later in time is used.

The UE complexity can be reduced by increasing the PUSCH preparation time (N2) by scaling factor u. The value u can be predefined or reported by a UE capability. For example, u equals to 2. Note: the new N2 values after scaling may be directly specified in the specification instead of specifying value u. u may be same as c. Alternatively, u may be different from c Corresponding to the increase of PUSCH preparation time, some other parameters may be increased too. The increase of processing time may be only applied if processingType2Enabled of PUSCH-ServingCellConfig is set to disable for a serving cell.

In one embodiment, the value d_{2,1} and/or d₂ in the formula to determine T_{proc,2} can be increased in accordance with the increase of N2.

In one option, the above value d_{2,1} and/or d₂ in the formula to determine T_{proc,2} can be increased by a scaling factor u₀. The value u₀ can be predefined or reported by a UE capability. Note: the new d_{2,1} and/or d₂ values after scaling may be directly specified in the specification instead of specifying value u₀.

In another option, the above value d_{1,1} and/or d₂ in the formula to determine T_{proc,2} may be not changed for eRedCap UE. Consequently, it is up to gNB implementation to meet the PUSCH preparation time.

In one embodiment, the value range of PDCCH to PUSCH scheduling offset (K2) can be increased in accordance with the increase of N2.

In one option, for DCI format 0_1 or 0_2, the value range of K2 can be changed to from X to Y. In one example, X>0, and Y is same as Rel-15, e.g. Y=31. In another example, X=0 and Y can be increased to 32u₁−1. In another example, X>0 and Y can be increased to 32u₁−1. The value u₁ can be predefined or reported by a UE capability. Note: the new range of K2 after scaling may be directly specified in the specification instead of specifying value u₁.

In another option, for DCI format 0_1 or 0_2, the value range of K2 may be not changed for eRedCap UE. Consequently, it is up to gNB implementation to not configure or indicate a value of K2 which results in short of PUSCH preparation time.

In one embodiment, the value range of PDCCH to PDSCH scheduling offset (K0) can be increased.

In one option, for DCI format 1_1 or 1_2, the value range of K0 can be changed to from X to Y. In one example, X>0, and Y is same as Rel-15, e.g. Y=31. In another example, X=0 and Y can be increased, e.g., to 32u₂−1. In another example, X>0 and Y can be increased, e.g., to 32u₂−1. The value u₂ can be predefined or reported by a UE capability. Note: the new range of K0 after scaling may be directly specified in the specification instead of specifying value u₂.

In another option, for DCI format 0_1 or 0_2, the value range of K2 may be not changed for eRedCap UE. Consequently, it is up to gNB implementation to not configure or indicate a value of K0 which results in short of PDSCH processing time.

In one embodiment, the maximum number of slots configured as minimum scheduling offset (K0)/(K2), e.g., the parameter maxKO-SchedulingOffset/maxK2-SchedulingOffset defined in TS 38.331 can be increased.

In one option, the maximum number of slots configured as minimum scheduling offset (K0)/(K2) may be increased by a scaling factor u₃. The value u₃ can be predefined or reported by a UE capability. Note: the new maximum number of slots configured as min. scheduling offset (K0)/(K2) after scaling may be directly specified in the specification instead of specifying value u₃. In another option, the maximum number of slots configured as min. scheduling offset (K0)/(K2) may be not changed for eRedCap UE.

In one embodiment, the application delay of the minimum scheduling offset restriction, Z_{μ} in 38.214 Section 5.3.1 can be increased.

In one option, the parameter Z_{μ} may be increased by a scaling factor u₄. The value u₄ can be predefined or reported by a UE capability. Note: the new range of Z_{μ} after scaling may be directly specified in the specification instead of specifying value u₄. In another option, the parameter Z_{μ} may be not changed for eRedCap UE.

In one embodiment, the value j for the determination of K2 in the default table for PUSCH time domain resource allocation can be increased in accordance with the increase of N2.

In section 6.1.2.1.1, TS38.214, the default TDRA table and value j are specified. However, the current value j is too small which results in some rows in the table not schedulable. For example, for SCS 1 kHz which uses j=1, if row 0 in the table is indicated with a PDCCH in the beginning 3 OFDM symbols in a slot, the scheduling delay without consideration of uplink timing advance is 11 symbols. However, with the increase of N2, e.g., 20 symbols for SCS 15 kHz assuming the existing N1 is doubled, there is insufficient scheduling delay for the PUSCH preparation at UE. In summary, there are 8 of 16 rows in the default TDRA table which are not applicable for SCS 15 kHz. On the other hand, for SCS 30 kHz with a timing advance larger than 1 OFDM symbol, 11 of 16 rows in the default TDRA table are not applicable. Therefore, the value j in the default TDRA table should be modified.

TABLE 6.1.2.1.1-2
Default PUSCH time domain resource allocation A for normal CP

| | PUSCH | | | |
|---|---|---|---|---|
| | mapping | | | |
| Row index | type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

TABLE 6.1.2.1.1-4
Definition of value j

| μ_{PUSCH} | j |
|---|---|
| 0 | 1 |
| 1 | 1 |
| 2 | 2 |
| 3 | 3 |
| 5 | 11 |
| 6 | 21 |

In one option, the value j in Table 6.1.2.1.1-4 in TS38.214 can be increased. In one example, the value j for each SCS can be increased by 1. In this example, the increased value j is only applicable to some of rows, e.g., the rows for PUSCH mapping type B, or the increased value j is applicable to all rows. In another example, since only SCS 15, 30 or 60 kHz are related to eRedCap operation, only the value j for SCS 15, 30 or 60 kHz can be increased by 1, e.g., j=2 for μ=0, j=2 for μ=1, j=3 for μ=2 if applicable. In this example, the increased value j is only applicable to some of rows, e.g., the rows for PUSCH mapping type B, or the increased value j is applicable to all rows. With this option, in initial access, it is assumed gNB can know the UE type, e.g., eRedCap UE or other UE, from the early identification of UE type, e.g., by Msg1, or Msg3 for 4-step RACH or MsgA for 2-step RACH.

In another option, the parameter j may be increased by a scaling factor u₅. The value u₅ can be predefined or reported by a UE capability. Note: the new value j after scaling may be directly specified in the specification instead of specifying value u₅. In another option, the parameter j may be not changed for eRedCap UE.

In another option, one more parameter Δⱼ is introduced for eRedCap UE. Consequently, the parameter j in the current specification can be replaced by j+Δⱼ. The value Δⱼ can be predefined, configured by high layer signaling or reported by a UE capability, e.g., Δⱼ=1.

In one embodiment, the slot delay value Δ that is applied in addition to the K₂ value for the UE to transmit a PUSCH scheduled by RAR or DCI format 0_0 with CRC scrambled by TC-RNTI or by the fallbackRAR can be increased. The slot delay value Δ is also applied in the determination of slot carrying PUCCH for HARQ-ACK feedback for Msg4/MsgB.

In NR, with reference to slots for a PUSCH transmission scheduled by a RAR UL grant, if a UE receives a PDSCH with a RAR message ending in slot n for a corresponding PRACH transmission from the UE, the UE transmits the PUSCH in slot n+k₂+Δ+2^{μ}·K_{cell,offset}, where k₂ and Δ are provided in [6, TS 38.214] and K_{cell,offset} is provided by CellSpecific_Koffset; otherwise, if not provided, K_{cell,offset}=0. Further in NR, for the transmission of a PUCCH with HARQ-ACK information having ACK value if the RAR message(s) is for successRAR, the slot for the PUCCH transmission is indicated by a HARQ Feedback Timing Indicator field of 3 bits in the successRAR having a value k from {1, 2, 3, 4, 5, 6, 7, 8} for μ≤3, from {7, 8, 12, 16, 20, 24, 28, 32} for μ=5, and from {13, 16, 24, 32, 40, 48, 56, 64} for μ=6 and, with reference to slots for PUCCH transmission having duration Tₛₗₒₜ, the slot is determined as n+k+Δ+2^{μ}. K_{cell,offset}, where n is a slot of the PDSCH reception, Δ is as defined for PUSCH transmission in Table 6.1.2.1.1-5 of [6, TS 38.214], μ is the SCS configuration of the active UL BWP, and K_{cell,offset} is provided by CellSpecific_Koffset; otherwise, if not provided, K_{cell,offset}=0. The value Δ is specified in Table 6.1.2.1.1-5 in TS38.214. The additional slot delay Δ is introduced to account for the MAC processing time of RAR PDSCH which include the UL grant for Msg3 or MsgB PUCCH transmission.

TABLE 6.1.2.1.1-5
Definition of value Δ

| μ_{PUSCH} | Δ |
|---|---|
| 0 | 2 |
| 1 | 3 |
| 2 | 4 |
| 3 | 6 |
| 5 | 24 |
| 6 | 48 |

In one option, the parameter Δ may be increased by a scaling factor u₆. The value u₆ can be predefined or reported by a UE capability. Note: the new value Δ after scaling may be directly specified in the specification instead of specifying value u₆. For example, for eRedCap, Δ=4 for μ=0, 4=6 for μ=1, Δ=8 for μ=2 if applicable.

In another example, the parameter Δ may be increased by a fixed number, e.g., 1 to account for longer processing time. For example, for eRedCap, Δ=3 for μ=0, Δ=4 for μ=1, 4=5 for μ=2 if applicable.

In another option, one more parameter δ is introduced for eRedCap UE. Consequently, the parameter Δ in the current specification can be replaced by Δ+δ. The value δ may be predefined, configured by high layer signaling or reported by a UE capability.

For above options, the increased value Δ is only applicable to some of rows, e.g., the rows for PUSCH mapping type B, or the increased value Δ is applicable to all rows.

In another option, the parameter Δ may be not changed for eRedCap UE.

In the above embodiments, the scaling factors u₀, u₁, u₂, u₃, u₄, u₅, u₆ may be equal to u respectively. Alternatively, the scaling factors u₀, u₁, u₂, u₃, u₄, u₅, u₆ may be different from u.

### Random Access Related Timeline

Multiple timelines are defined between the different messages and related control signaling transmission in the random access procedure. Due to the relaxed PDSCH/PUSCH processing time, the above timelines may need to be relaxed accordingly.

In one embodiment, the parameter Δ_{Delay} in the determination of delay between a PDCCH order and the PRACH preamble may be increased.

In section 8.1, TS38.213 in NR, if a random access procedure is initiated by a PDCCH order, the UE, if requested by higher layers, transmits a PRACH in the selected PRACH occasion, as described in [11, TS 38.321], for which a time between the last symbol of the PDCCH order reception and the first symbol of the PRACH transmission is larger than or equal to N_{T,2}+Δ_{BWPSwitching}+Δ_{Delay}+T_{switch} msec. Δ_{Delay}=0.5 msec for FR1 and Δ_{Delay}=0.25 msec for FR2.

In one option, Δ_{Delay} may be increased by a scaling factor r₀. The value r₀ can be predefined or reported by a UE capability. Note: the new Δ_{Delay} after scaling may be directly specified in the specification instead of specifying value r₀. For example, for eRedCap, Δ_{Delay} is increased to 1 msec. In another option, Δ_{Delay} may be not changed for eRedCap UE.

In one embodiment, the additional delay of 0.75 ms when high layer trigger a retransmission of PRACH preamble after a RAR window may be increased for eRedCap UE. This embodiment may be applicable to both 2-step RACH and 4-step RACH.

For example, for 4-step RACH in section 8.2, TS38.213 in NR, if the UE does not detect the DCI format 1_0 with CRC scrambled by the corresponding RA-RNTI within the window, or if the UE detects the DCI format 1_0 with CRC scrambled by the corresponding RA-RNTI within the window and LSBs of a SFN field in the DCI format 1_0, if included and applicable, are not same as corresponding LSBs of the SFN where the UE transmitted PRACH, or if the UE does not correctly receive the transport block in the corresponding PDSCH within the window, or if the higher layers do not identify the RAPID associated with the PRACH transmission from the UE, the higher layers can indicate to the physical layer to transmit a PRACH. If requested by higher layers, the UE is expected to transmit a PRACH no later than N_{T,1}+0.75 msec after the last symbol of the window, or the last symbol of the PDSCH reception, where N_{T,1} is a time duration of N₁ symbols corresponding to a PDSCH processing time for UE processing capability 1 assuming μ corresponds to the smallest SCS configuration among the SCS configurations for the PDCCH carrying the DCI format 1_0, the corresponding PDSCH when additional PDSCH DM-RS is configured, and the corresponding PRACH.

In one option, the additional delay may be increased by a scaling factor r₁. The value r₁ can be predefined or reported by a UE capability. Note: the additional delay after scaling may be directly specified in the specification instead of specifying value r₁. For example, for eRedCap, the additional delay is increased to 1.5 msec. Alternatively, the additional delay may be not changed for eRedCap UE.

In one embodiment, the additional delay of 0.5 ms between a RAR message of successRAR and the associated PUCCH may be increased for eRedCap UE.

In section 8.2A, TS38.213 in NR, for the transmission of a PUCCH with HARQ-ACK information having ACK value if the RAR message(s) is for successRAR, the UE does not expect the first symbol of the PUCCH transmission to be after the last symbol of the PDSCH reception by a time smaller than N_{T,1}+0.5 msec where N_{T,1} is the PDSCH processing time for UE processing capability 1 [6, TS 38.214]

In one option, the additional delay may be increased by a scaling factor r₂, e.g., 0.5r₂ ms The value r₂ can be predefined or reported by a UE capability. Note: the additional delay after scaling may be directly specified in the specification instead of specifying value r₂. For example, for eRedCap, the additional delay is increased to 1 msec. For example, the additional delay may be increased to 0.5+Y ms. In other words, the UE does not expect the first symbol of the PUCCH transmission to be after the last symbol of the PDSCH reception by a time smaller than N_{T,1}+0.5+Y msec. The value Y can be predefined, configured by high layer signaling or reported by a UE capability. The value Y may be same as or different from the value X in the next embodiment. Alternatively, the additional delay may be not changed for eRedCap UE.

In one embodiment, the additional delay of 0.5 ms between a RAR message and corresponding PUSCH transmission scheduled by the RAR UL grant may be increased for eRedCap UE.

In section 8.3, TS38.213 in NR, the UE may assume a minimum time between the last symbol of a PDSCH reception conveying a RAR message with a RAR UL grant and the first symbol of a corresponding PUSCH transmission scheduled by the RAR UL grant is equal to N_{T,1}+N_{T,2}+0.5 msec, where N_{T,1} is a time duration of N₁ symbols corresponding to a PDSCH processing time for UE processing capability 1 when additional PDSCH DM-RS is configured, N_{T,2} is a time duration of N2 symbols corresponding to a PUSCH preparation time for UE processing capability 1 [6, TS 38.214] and, for determining the minimum time, the UE considers that N₁ and N₂ correspond to the smaller of the SCS configurations for the PDSCH and the PUSCH. For μ=0, the UE assumes N_{1,0}=14 [6, TS 38.214].

In one option, the additional delay may be increased by a scaling factor r₃, e.g., 0.5r₃ ms. The value r₃ can be predefined or reported by a UE capability. r₃ may be equal to u. Alternatively, r₃ may be different from u. Note: the additional delay after scaling may be directly specified in the specification instead of specifying value r₃. For example, for eRedCap, the additional delay is increased to 1 msec. For example, the additional delay may be increased to 0.5+X ms. In other words, the UE may assume a minimum time between the last symbol of a PDSCH reception conveying a RAR message with a RAR UL grant or fallbackRAR and the first symbol of a corresponding PUSCH transmission scheduled by the RAR UL grant or fallbackRAR is equal to N_{T,1}+N_{T,2}+0.5+X msec. The value X can be predefined, configured by high layer signaling or reported by a UE capability. The value X may be same as or different from the value Y in the previous embodiment. Alternatively, the additional delay may be not changed for eRedCap UE.

In one embodiment, the additional delay of 0.5 ms between Msg4 or MsgB and corresponding HARQ-ACK transmission on PUCCH may be increased for eRedCap UE.

In section 8.4, TS38.213 in NR, in response to the PDSCH reception with the UE contention resolution identity, the UE transmits HARQ-ACK information in a PUCCH. A minimum time between the last symbol of the PDSCH reception and the first symbol of the corresponding PUCCH transmission with the HARQ-ACK information is equal to N_{T,1}+0.5 msec. Similarly, in section 8.2A, 3GPP TS38.213, the UE does not expect the first symbol of the PUCCH transmission to be after the last symbol of the PDSCH reception by a time smaller than N_{T,1}+0.5 msec where N_{T,1} is the PDSCH processing time for UE processing capability 1 [6, TS 38.214].

In one option, the additional delay may be increased by a scaling factor r₄, e.g., 0.5r₄ ms. The value r₄ can be predefined or reported by a UE capability. Note: the additional delay after scaling may be directly specified in the specification instead of specifying value r₄. For example, for eRedCap, the additional delay is increased to 1 msec. For example, the additional delay may be increased to 0.5+Z ms. In other words, the UE may assume a minimum time between the last symbol of a PDSCH reception conveying Msg4 and the first symbol of a corresponding PUCCH transmission with the HARQ-ACK information is equal to N_{T,1}+0.5+Z msec. The value Z can be predefined, configured by high layer signaling or reported by a UE capability. The value Z may be same as or different from the value X or Y in the previous two embodiments. Alternatively, the additional delay may be not changed for eRedCap UE.

In one embodiment, the minimum gap between a PRACH transmission and a PUSCH/PUCCH/SRS may be increased for eRedCap UE.

In section 8.1, TS38.213 in NR, for single cell operation or for operation with carrier aggregation in a same frequency band, a UE does not transmit PRACH and PUSCH/PUCCH/SRS in a same slot or when a gap between the first or last symbol of a PRACH transmission in a first slot is separated by less than N symbols from the last or first symbol, respectively, of a PUSCH/PUCCH/SRS transmission in a second slot where N=2 for μ=0 or μ=1, N=4 for μ=2 or μ=3, N=16 for μ=5, N=32 for μ=6, and μ is the SCS configuration for the active UL BWP. For a PUSCH transmission with repetition Type B, this applies to each actual repetition for PUSCH transmission [6, TS 38.214].

In one option, a eRedCap UE does not transmit PRACH and PUSCH/PUCCH/SRS within g consecutive slots. The value g can be predefined or reported by a UE capability. For example, g=2 for eRedCap. Alternatively, the limitation on no PRACH and PUSCH/PUCCH/SRS transmission in a same slot is not changed or eRedCap UE.

In another option, the minimum gap of N symbols between a PRACH transmission and a PUSCH/PUCCH/SRS may be increased by a scaling factor g. The value g can be predefined or reported by a UE capability. Note: the new value N after scaling may be directly specified in the specification instead of specifying value g. For example, for eRedCap, g=4 for μ=0, g=4 for μ=1, g=8 for μ=2 if applicable. Alternatively, the minimum gap of N symbols between a PRACH transmission and a PUSCH/PUCCH/SRS may be not changed for eRedCap UE.

In the above embodiments, the scaling factors r₀, r₁, r₂, r₃, r₄, g may be equal to c and/or u respectively. Alternatively, the scaling factors r₀, r₁, r₂, r₃, r₄, g may be different from c or.

### Relaxed CSI Computation Delay

The UE complexity can be reduced by increasing the CSI computation delay (Z & Z′ in section 5.4 in TS38.214) by scaling factor z. The value z can be predefined or reported by a UE capability. For example, z equals to 2. Note: the new Z & Z′ values after scaling may be directly specified in the specification instead of specifying value z. Corresponding to the increase of CSI computation delay, some other parameters may be increased too.

In one embodiment, n_{CSI_ref} that is used to determine the CSI reference resource for a serving cell can be adjusted in accordance to the increase of Z & Z′.

In section 5.2.2.5 in TS38.214, the CSI reference resource in time domain for a serving cell for a CSI reporting in uplink slot n′ is defined by a single downlink

$$slot n - {n}_{CSI\_ref} - {K}_{offset} \cdot \frac{{2}^{{μ}_{DL}}}{{2}^{{μ}_{{K}_{offset}}}} ,$$

where K_{offset} is a parameter configured by higher layer as specified in clause 4.2 of [6 TS 38.213], and where μ_{K}_{_{offset}} is the subcarrier spacing configuration for K_{offset} with a value of 0 for frequency range 1, where for periodic and semi-persistent CSI reporting
if a single CSI-RS/SSB resource is configured for channel measurement n_{CSI_ref} is the smallest value greater than or equal to 4·2^{μ}^{_{DL}}, such that it corresponds to a valid downlink slot, or
if multiple CSI-RS/SSB resources are configured for channel measurement n_{CSI_ref} is the smallest value greater than or equal to 5·2^{μ}^{_{DL}}, such that it corresponds to a valid downlink slot.

In one option, in the determination of CSI reference resource, for periodic and semi-persistent CSI reporting
if a single CSI-RS/SSB resource is configured for channel measurement n_{CSI_ref} is the smallest value greater than or equal to 4z₀·2^{μ}^{_{DL}}, such that it corresponds to a valid downlink slot, or
if multiple CSI-RS/SSB resources are configured for channel measurement n_{CSI_ref} is the smallest value greater than or equal to 5z₀·2^{μ}^{_{DL}}, such that it corresponds to a valid downlink slot.

The value z₀ can be predefined or reported by a UE capability. The scaling factor z₀ may be equal to z. Alternatively, the scaling factor z₀ may be different from z.

### Systems and Implementations

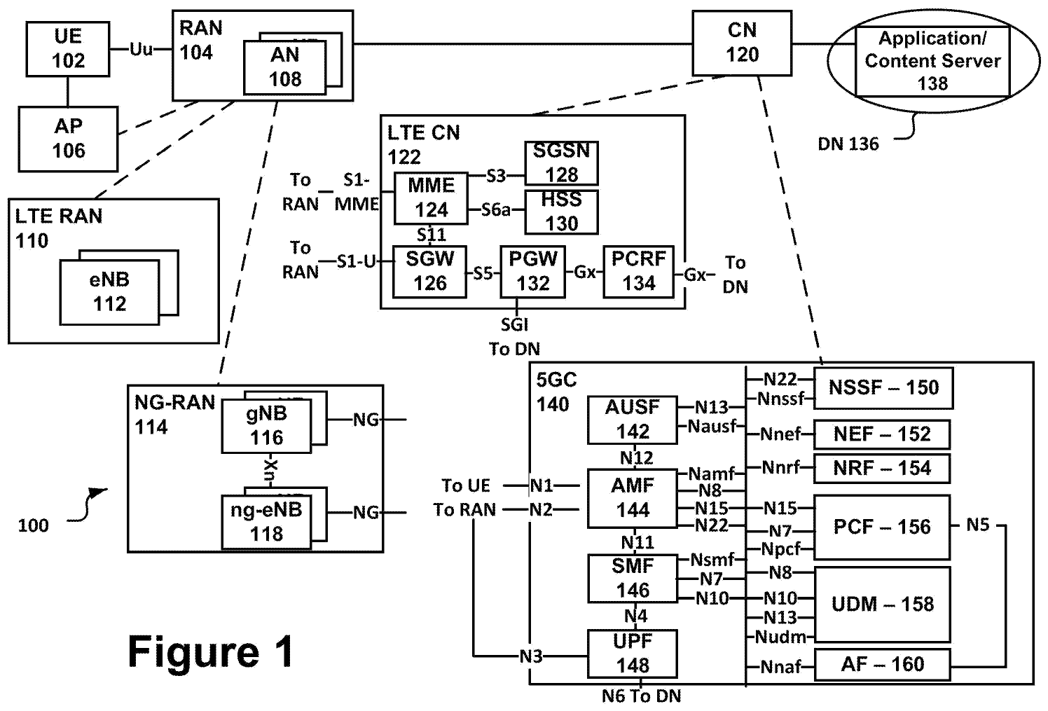

FIGS. 1-3 illustrate various systems, devices, and components that may implement aspects of disclosed embodiments.

FIG. 1 illustrates a network 100 in accordance with various embodiments. The network 100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 100 may include a UE 102, which may include any mobile or non-mobile computing device designed to communicate with a RAN 104 via an over-the-air connection. The UE 102 may be communicatively coupled with the RAN 104 by a Uu interface. The UE 102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102 may additionally communicate with an AP 106 via an over-the-air connection. The AP 106 may manage a WLAN connection, which may serve to offload some/all network traffic from the RAN 104. The connection between the UE 102 and the AP 106 may be consistent with any IEEE 802.11 protocol, wherein the AP 106 could be a wireless fidelity (Wi-Fi®) router. In some embodiments, the UE 102, RAN 104, and AP 106 may utilize cellular-WLAN aggregation (for example, LWA/LWIP). Cellular-WLAN aggregation may involve the UE 102 being configured by the RAN 104 to utilize both cellular radio resources and WLAN resources.

The RAN 104 may include one or more access nodes, for example, AN 108. AN 108 may terminate air-interface protocols for the UE 102 by providing access stratum protocols including RRC, PDCP, RLC, MAC, and L1 protocols. In this manner, the AN 108 may enable data/voice connectivity between CN 120 and the UE 102. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102 with an air interface for network access. The UE 102 may be simultaneously connected with a plurality of cells provided by the same or different ANs of the RAN 104. For example, the UE 102 and RAN 104 may use carrier aggregation to allow the UE 102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 102 or AN 108 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNBs, for example, eNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 104 may be an NG-RAN 114 with gNBs, for example, gNB 116, or ng-eNBs, for example, ng-eNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN 114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102 can be configured with multiple BWPs where each BWP configuration has a different SCS. When a BWP change is indicated to the UE 102, the SCS of the transmission is changed as well. Another use case example of BWP is related to power saving. In particular, multiple BWPs can be configured for the UE 102 with different amount of frequency resources (for example, PRBs) to support data transmission under different traffic loading scenarios. A BWP containing a smaller number of PRBs can be used for data transmission with small traffic load while allowing power saving at the UE 102 and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows.

The MME 124 may implement mobility management functions to track a current location of the UE 102 to facilitate paging, bearer activation/deactivation, handovers, gateway selection, authentication, etc.

The SGW 126 may terminate an SI interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102 and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an SGi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the SGi reference point between the PGW 132 and the data network 136 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, and AF 160 coupled with one another over interfaces (or “reference points”) as shown. Functions of the elements of the 5GC 140 may be briefly introduced as follows.

The AUSF 142 may store data for authentication of UE 102 and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102 and the RAN 104 and to subscribe to notifications about mobility events with respect to the UE 102. The AMF 144 may be responsible for registration management (for example, for registering UE 102), connection management, reachability management, mobility management, lawful interception of AMF-related events, and access authentication and authorization. The AMF 144 may provide transport for SM messages between the UE 102 and the SMF 146, and act as a transparent proxy for routing SM messages. AMF 144 may also provide transport for SMS messages between UE 102 and an SMSF. AMF 144 may interact with the AUSF 142 and the UE 102 to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling, and perform NAS ciphering and integrity protection. AMF 144 may also support NAS signaling with the UE 102 over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102 and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102. The NSSF 150 may also determine allowed NSSAI and the mapping to the subscribed S-NSSAIs, if needed. The NSSF 150 may also determine the AMF set to be used to serve the UE 102, or a list of candidate AMFs based on a suitable configuration and possibly by querying the NRF 154. The selection of a set of network slice instances for the UE 102 may be triggered by the AMF 144 with which the UE 102 is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 may handle subscription-related information to support the network entities' handling of communication sessions, and may store subscription data of UE 102. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102) for the NEF 152. The Nudr service-based interface may be exhibited by the UDR 221 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3^{rd} party services to be geographically close to a point that the UE 102 is attached to the network. This may reduce latency and load on the network. To provide edge-computing implementations, the 5GC 140 may select a UPF 148 close to the UE 102 and execute traffic steering from the UPF 148 to data network 136 via the N6 interface. This may be based on the UE subscription data, UE location, and information provided by the AF 160. In this way, the AF 160 may influence UPF (re) selection and traffic routing. Based on operator deployment, when AF 160 is considered to be a trusted entity, the network operator may permit AF 160 to interact directly with relevant NFs. Additionally, the AF 160 may exhibit an Naf service-based interface.

The data network 136 may represent various network operator services, Internet access, or third party services that may be provided by one or more servers including, for example, application/content server 138.

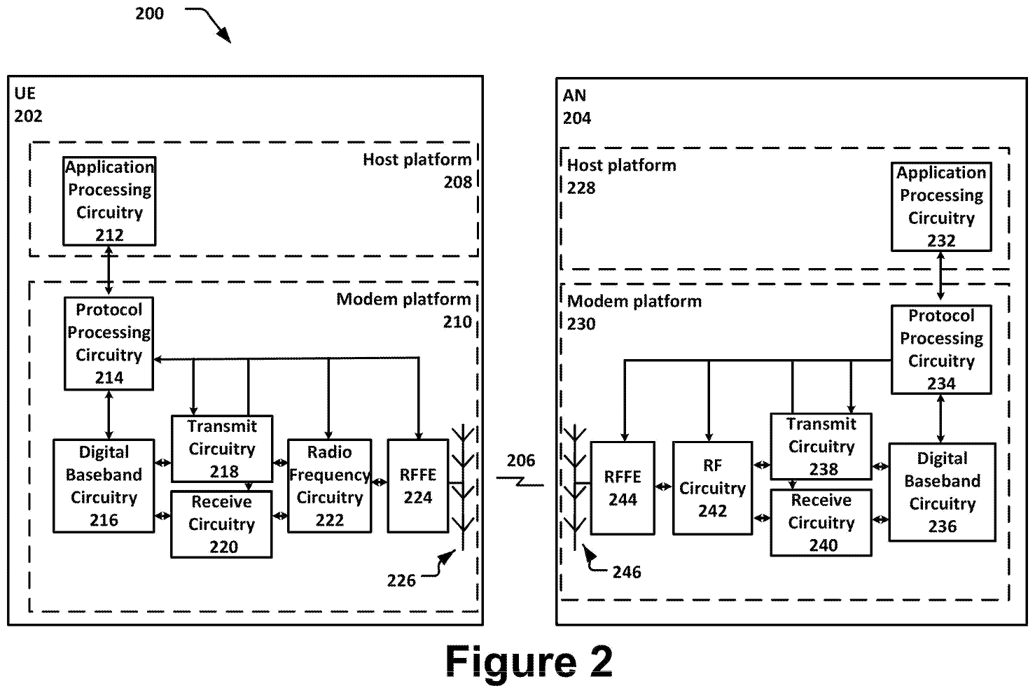

FIG. 2 schematically illustrates a wireless network 200 in accordance with various embodiments. The wireless network 200 may include a UE 202 in wireless communication with an AN 204. The UE 202 and AN 204 may be similar to, and substantially interchangeable with, like-named components described elsewhere herein.

The UE 202 may be communicatively coupled with the AN 204 via connection 206. The connection 206 is illustrated as an air interface to enable communicative coupling, and can be consistent with cellular communications protocols such as an LTE protocol or a 5G NR protocol operating at mm Wave or sub-6 GHz frequencies.

The UE 202 may include a host platform 208 coupled with a modem platform 210. The host platform 208 may include application processing circuitry 212, which may be coupled with protocol processing circuitry 214 of the modem platform 210. The application processing circuitry 212 may run various applications for the UE 202 that source/sink application data. The application processing circuitry 212 may further implement one or more layer operations to transmit/receive application data to/from a data network. These layer operations may include transport (for example UDP) and Internet (for example, IP) operations

The protocol processing circuitry 214 may implement one or more of layer operations to facilitate transmission or reception of data over the connection 206. The layer operations implemented by the protocol processing circuitry 214 may include, for example, MAC, RLC, PDCP, RRC and NAS operations.

The modem platform 210 may further include digital baseband circuitry 216 that may implement one or more layer operations that are “below” layer operations performed by the protocol processing circuitry 214 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 210 may further include transmit circuitry 218, receive circuitry 220, RF circuitry 222, and RF front end (RFFE) 224, which may include or connect to one or more antenna panels 226. Briefly, the transmit circuitry 218 may include a digital-to-analog converter, mixer, intermediate frequency (IF) components, etc.; the receive circuitry 220 may include an analog-to-digital converter, mixer, IF components, etc.; the RF circuitry 222 may include a low-noise amplifier, a power amplifier, power tracking components, etc.; RFFE 224 may include filters (for example, surface/bulk acoustic wave filters), switches, antenna tuners, beamforming components (for example, phase-array antenna components), etc. The selection and arrangement of the components of the transmit circuitry 218, receive circuitry 220, RF circuitry 222, RFFE 224, and antenna panels 226 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 214 may include one or more instances of control circuitry (not shown) to provide control functions for the transmit/receive components.

A UE reception may be established by and via the antenna panels 226, RFFE 224, RF circuitry 222, receive circuitry 220, digital baseband circuitry 216, and protocol processing circuitry 214. In some embodiments, the antenna panels 226 may receive a transmission from the AN 204 by receive-beamforming signals received by a plurality of antennas/antenna elements of the one or more antenna panels 226.

A UE transmission may be established by and via the protocol processing circuitry 214, digital baseband circuitry 216, transmit circuitry 218, RF circuitry 222, RFFE 224, and antenna panels 226. In some embodiments, the transmit components of the UE 204 may apply a spatial filter to the data to be transmitted to form a transmit beam emitted by the antenna elements of the antenna panels 226.

Similar to the UE 202, the AN 204 may include a host platform 228 coupled with a modem platform 230. The host platform 228 may include application processing circuitry 232 coupled with protocol processing circuitry 234 of the modem platform 230. The modem platform may further include digital baseband circuitry 236, transmit circuitry 238, receive circuitry 240, RF circuitry 242, RFFE circuitry 244, and antenna panels 246. The components of the AN 204 may be similar to and substantially interchangeable with like-named components of the UE 202. In addition to performing data transmission/reception as described above, the components of the AN 208 may perform various logical functions that include, for example, RNC functions such as radio bearer management, uplink and downlink dynamic radio resource management, and data packet scheduling.

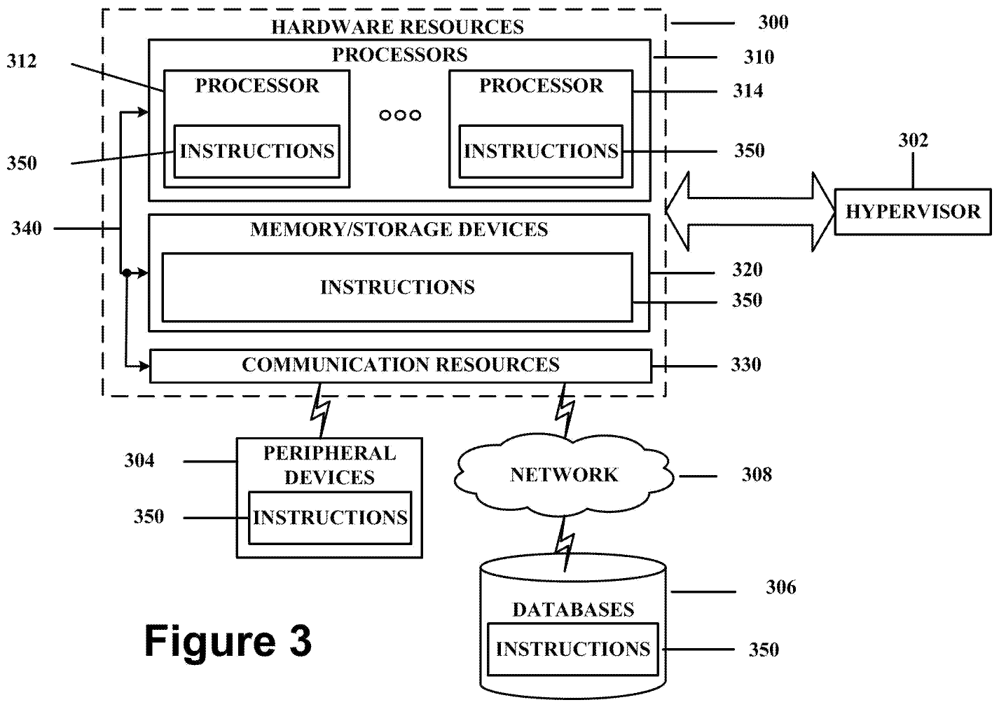

FIG. 3 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 3 shows a diagrammatic representation of hardware resources 300 including one or more processors (or processor cores) 310, one or more memory/storage devices 320, and one or more communication resources 330, each of which may be communicatively coupled via a bus 340 or other interface circuitry. For embodiments where node virtualization (e.g., NFV) is utilized, a hypervisor 302 may be executed to provide an execution environment for one or more network slices/sub-slices to utilize the hardware resources 300.

The processors 310 may include, for example, a processor 312 and a processor 314. The processors 310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 320 may include main memory, disk storage, or any suitable combination thereof. The memory/storage devices 320 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 330 may include interconnection or network interface controllers, components, or other suitable devices to communicate with one or more peripheral devices 304 or one or more databases 306 or other network elements via a network 308. For example, the communication resources 330 may include wired communication components (e.g., for coupling via USB, Ethernet, etc.), cellular communication components, NFC components, Bluetooth® (or Bluetooth® Low Energy) components, Wi-Fi® components, and other communication components.

Instructions 350 may comprise software, a program, an application, an applet, an app, or other executable code for causing at least any of the processors 310 to perform any one or more of the methodologies discussed herein. The instructions 350 may reside, completely or partially, within at least one of the processors 310 (e.g., within the processor's cache memory), the memory/storage devices 320, or any suitable combination thereof. Furthermore, any portion of the instructions 350 may be transferred to the hardware resources 300 from any combination of the peripheral devices 304 or the databases 306. Accordingly, the memory of processors 310, the memory/storage devices 320, the peripheral devices 304, and the databases 306 are examples of computer-readable and machine-readable media.

### Example Procedures

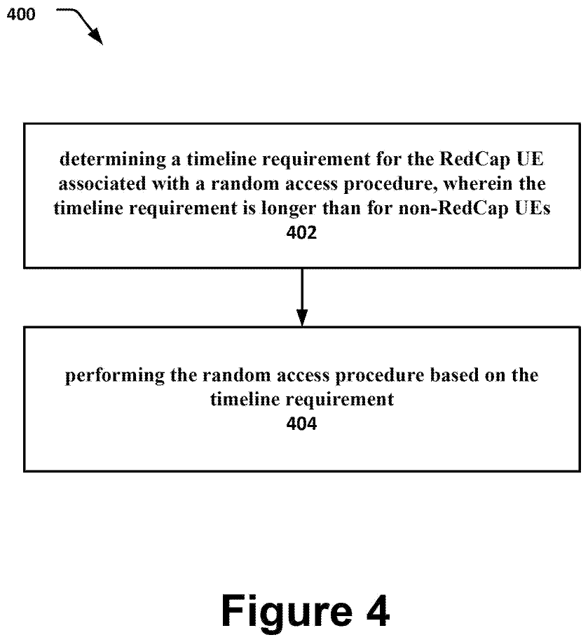

FIG. 4 illustrates an example process 400 in accordance with various embodiments herein. The process 400 may be performed by a RedCap UE or a portion thereof. At 402, the process 400 may include determining a timeline requirement for the RedCap UE associated with a random access procedure, wherein the timeline requirement is longer than for non-RedCap UEs. At 404, the process 400 may further include performing the random access procedure based on the timeline requirement.

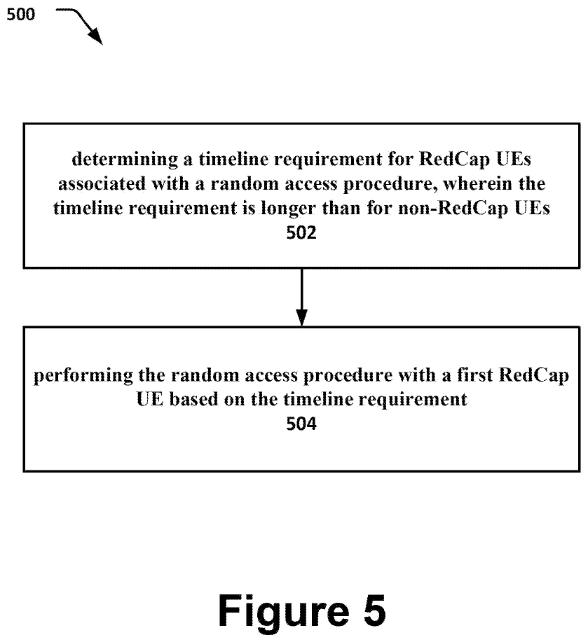

FIG. 5 illustrates an example process 500 in accordance with various embodiments herein. The process 500 may be performed by a next generation Node B (gNB) or a portion thereof. At 502, the process 500 may include determining a timeline requirement for RedCap UEs associated with a random access procedure, wherein the timeline requirement is longer than for non-RedCap UEs. At 504, the process 500 may further include performing the random access procedure with a first RedCap UE based on the timeline requirement.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Some non-limiting examples of various embodiments are provided below.

Example A1 may include one or more non-transitory computer-readable media (NTCRM) having instructions, stored thereon, that when executed by one or more processors of a reduced capability (RedCap) user equipment (UE), configure the UE to: determine a timeline requirement for the RedCap UE associated with a random access procedure, wherein the timeline requirement is longer than for non-RedCap UEs; and perform the random access procedure based on the timeline requirement.

Example A2 may include the one or more NTCRM of example A1, wherein to perform the random access procedure includes to retransmit a physical random access channel (PRACH) in accordance with the timeline requirement.

Example A3 may include the one or more NTCRM of example A2, wherein the instructions, when executed, further configure the RedCap UE to: perform an initial transmission of the PRACH; and receive a random access response (RAR) physical downlink shared channel (PDSCH); wherein the timeline requirement corresponds to a time period between reception of the RAR PDSCH and the retransmission of the PRACH.

Example A4 may include the one or more NTCRM of example A3, wherein the retransmission of the PRACH is performed if the RedCap UE does not correctly receive a transport block of the RAR PDSCH.

Example A5 may include the one or more NTCRM of example A3, wherein the retransmission of the PRACH is performed if a RAPID of the RAR PDSCH is not associated with the initial transmission of the PRACH.

Example A6 may include the one or more NTCRM of example A1, wherein the timeline requirement corresponds to a minimum time period between reception of a fallback random access response (RAR) and transmission of a Msg3 by the RedCap UE.

Example A7 may include the one or more NTCRM of example A6, wherein the time period is equal to N_{T,1}+N_{T,2}+0.5+X milliseconds, wherein: N_{T,1} is a time duration of N₁ symbols corresponding to a PDSCH processing time for UE processing capability 1 when an additional PDSCH demodulation reference signal (DM-RS) is configured; N_{T,2} is a time duration of N₂ symbols corresponding to a physical uplink shared channel (PUSCH) preparation time for UE processing capability 1; and X is an additional time allocation for RedCap UEs.

Example A8 may include the one or more NTCRM of example A1, wherein the timeline requirement corresponds to a time period between a success random access response (RAR) and transmission of a corresponding hybrid automatic repeat request (HARQ)-acknowledgement (ACK) by the RedCap UE.

Example A9 may include the one or more NTCRM of example A1-A8, wherein the timeline requirement is 1 slot for a Msg2 physical downlink shared channel (PDSCH) larger than 25 physical resource blocks (PRBs) for a subcarrier spacing (SCS) of 15 kilohertz (kHz) or larger than 12 PRBs for a SCS of 30 kHz.

Example A10 may include one or more non-transitory computer-readable media (NTCRM) having instructions, stored thereon, that when executed by one or more processors of a next generation Node B (gNB), configure the gNB to: determine a timeline requirement for RedCap UEs associated with a random access procedure, wherein the timeline requirement is longer than for non-RedCap UEs; and perform the random access procedure with a first RedCap UE based on the timeline requirement.

Example A11 may include the one or more NTCRM of example A10, wherein to perform the random access procedure includes to receive a retransmission of a physical random access channel (PRACH) in accordance with the timeline requirement.

Example A12 may include the one or more NTCRM of example A11, wherein the instructions, when executed, further configure the gNB to: transmit a random access response (RAR) physical downlink shared channel (PDSCH) to the RedCap UE, wherein the timeline requirement corresponds to a time period between reception of the RAR PDSCH by the RedCap UE and the retransmission of the PRACH.

Example A13 may include the one or more NTCRM of example A12, wherein the retransmission of the PRACH is performed if the RedCap UE does not correctly receive a transport block of the RAR PDSCH or if a RAPID of the RAR PDSCH is not associated with the initial transmission of the PRACH.

Example A14 may include the one or more NTCRM of example A10, wherein the timeline requirement corresponds to a minimum time period between reception of a fallback random access response (RAR) by the RedCap UE and transmission of a Msg3 by the RedCap UE.

Example A15 may include the one or more NTCRM of example A14, wherein the time period is equal to N_{T,1}+N_{T,2}+0.5+X milliseconds, wherein: N_{T,1} is a time duration of N₁ symbols corresponding to a PDSCH processing time for UE processing capability 1 when an additional PDSCH demodulation reference signal (DM-RS) is configured; N_{T,2} is a time duration of N₂ symbols corresponding to a physical uplink shared channel (PUSCH) preparation time for UE processing capability 1; and X is an additional time allocation for RedCap UEs.

Example A16 may include the one or more NTCRM of example A10, wherein the timeline requirement corresponds to a time period between a success random access response (RAR) and transmission of a corresponding hybrid automatic repeat request (HARQ)-acknowledgement (ACK) by the RedCap UE.

Example A17 may include the one or more NTCRM of example A10-A16, wherein the timeline requirement is 1 slot for a Msg2 physical downlink shared channel (PDSCH) larger than 25 physical resource blocks (PRBs) for a subcarrier spacing (SCS) of 15 kilohertz (kHz) or larger than 12 PRBs for a SCS of 30 kHz.

Example A18 may include an apparatus to be implemented in a reduced capability (RedCap) user equipment (UE), the apparatus comprising: a memory to store an indication of a timeline requirement associated with a random access procedure, wherein the timeline requirement is longer than for non-RedCap UEs; and processor circuitry coupled to the memory, wherein, to perform the random access procedure, the processor circuitry is to: encode, for transmission to a next generation Node B (gNB), a physical random access channel (PRACH); receive a random access response (RAR) physical downlink shared channel (PDSCH); and encode a subsequent message for transmission based on the timeline requirement, wherein the timeline requirement corresponds to a time period between the reception of the RAR PDSCH and the transmission of the subsequent message.

Example A19 may include the apparatus of example A18, wherein the subsequent message is a Msg3 or a retransmission of the PRACH.

Example A20 may include the apparatus of example A18-A19, wherein the time period is equal to N_{T,1}+N_{T,2}+0.5+X milliseconds, wherein: N_{T,1} is a time duration of N₁ symbols corresponding to a PDSCH processing time for UE processing capability 1 when an additional PDSCH demodulation reference signal (DM-RS) is configured; N_{T,2} is a time duration of N₂ symbols corresponding to a physical uplink shared channel (PUSCH) preparation time for UE processing capability 1; and X is an additional time allocation for RedCap UEs.

Example B1 may include a method for relaxed processing time for UE with reduced bandwidth.

Example B2 may include the method of example B1 or some other example herein, wherein the values of d_{1,1} and/or d₂ in the formula to determine T_{proc,1} is increased.

Example B3 may include the method of example B1 or some other example herein, wherein the value range of PDSCH-to-HARQ_feedback slot offset (K1) is increased.

Example B4 may include the method of example B1 or some other example herein, wherein the value N₃ of HARQ-ACK multiplexing timeline is increased.

Example B5 may include the method of example B1 or some other example herein, wherein the value N of HARQ-ACK feedback timeline for SPS PDSCH release is increased.

Example B6 may include the method of example B1 or some other example herein, wherein the value d_{2,1} and/or d₂ in the formula to determine T_{proc,2} is increased.

Example B7 may include the method of example B1 or some other example herein, wherein the value range of PDCCH to PUSCH scheduling offset (K2) is increased.

Example B8 may include the method of example B1 or some other example herein, wherein the value range of PDCCH to PDSCH scheduling offset (K0) is increased.

Example B9 may include the method of example B1 or some other example herein, wherein the maximum number of slots configured as minimum scheduling offset (K0)/(K2) is increased.

Example B10 may include the method of example B1 or some other example herein, wherein the application delay of the minimum scheduling offset restriction Zμ is increased.

Example B11 may include the method of example B1 or some other example herein, wherein the value j for the determination of K2 in the default table for PUSCH time domain resource allocation is increased.

Example B12 may include the method of example B1 or some other example herein, wherein the slot delay value Δ that is applied in addition to the K2 value for the UE to transmit a PUSCH scheduled by RAR or DCI format 0_0 with CRC scrambled by TC-RNTI or by the fallbackRAR is increased.

Example B13 may include the method of example B1 or some other example herein, wherein the processing time between the different messages and related control signaling transmission in the random access procedure is increased.

Example B14 may include the method of example B1 or some other example herein, wherein nCSI_ref that is used to determine the CSI reference resource for a serving cell is adjusted.

Example B15 may include a method of a reduced capability (RedCap) UE, the method comprising:
determining a processing time designated for RedCap UEs, wherein the processing time is longer than for non-RedCap UEs; and
communicating over a wireless cellular network based on the processing time.

Example B16 may include the method of example B15 or some other example herein, wherein the determining the processing time includes determining a T_{proc,1} based on a d_{1,1} and/or d₂ that has a greater value for the RedCap UEs than for the non-RedCap UEs.

Example B17 may include the method of example B15-B16 or some other example herein, wherein the determining the processing time includes determining a T_{proc,2} based on a d_{2,1} and/or d₂ that has a greater value for the RedCap UEs than for the non-RedCap UEs.

Example B18 may include the method of example B15-B17 or some other example herein, wherein the processing time corresponds to one or more of:
a value range of PDSCH-to-HARQ_feedback slot offset (K1);
a value N₃ of HARQ-ACK multiplexing timeline;
a value N of HARQ-ACK feedback timeline for SPS PDSCH release;
a value range of PDCCH to PUSCH scheduling offset (K2);
a value range of PDCCH to PDSCH scheduling offset (K0);
a maximum number of slots configured as minimum scheduling offset (K0)/(K2);
an application delay of the minimum scheduling offset restriction Zμ;
a value j for the determination of K2 in the default table for PUSCH time domain resource allocation;
a slot delay value Δ that is applied in addition to the K2 value for the UE to transmit a PUSCH scheduled by RAR or DCI format 0_0 with CRC scrambled by TC-RNTI or by the fallbackRAR;
a processing time between a message and related control signaling transmission in a random access procedure; and/or
a nCSI_ref that is used to determine the CSI reference resource for a serving cell.

Example B19 may include a method of a next generation Node B (gNB), the method comprising:
determining a processing time designated for reduced capability (RedCap) UEs, wherein the processing time is longer than for non-RedCap UEs; and
communicating with a RedCap UE over a wireless cellular network based on the processing time.

Example B20 may include the method of example B19 or some other example herein, wherein the determining the processing time includes determining a T_{proc,1} based on a d_{1,1} and/or d₂ that has a greater value for the RedCap UEs than for the non-RedCap UEs.

Example B21 may include the method of example B19-B20 or some other example herein, wherein the determining the processing time includes determining a T_{proc,2} based on a d_{2,1} and/or d₂ that has a greater value for the RedCap UEs than for the non-RedCap UEs.

Example B22 may include the method of example B19-B21 or some other example herein, wherein the processing time corresponds to one or more of:
a value range of PDSCH-to-HARQ_feedback slot offset (K1);
a value N₃ of HARQ-ACK multiplexing timeline;
a value N of HARQ-ACK feedback timeline for SPS PDSCH release;
a value range of PDCCH to PUSCH scheduling offset (K2);
a value range of PDCCH to PDSCH scheduling offset (K0);
a maximum number of slots configured as minimum scheduling offset (K0)/(K2);
an application delay of the minimum scheduling offset restriction Zμ;
a value j for the determination of K2 in the default table for PUSCH time domain resource allocation;
a slot delay value Δ that is applied in addition to the K2 value for the UE to transmit a PUSCH scheduled by RAR or DCI format 0_0 with CRC scrambled by TC-RNTI or by the fallbackRAR;
a processing time between a message and related control signaling transmission in a random access procedure; and/or
a nCSI_ref that is used to determine the CSI reference resource for a serving cell.

Example Z01 may include an apparatus comprising means to perform one or more elements of a method described in or related to any of examples A1-A20, B1-B22, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A20, B1-B22, or any other method or process described herein.

Example Z03 may include an apparatus comprising logic, modules, or circuitry to perform one or more elements of a method described in or related to any of examples A1-A20, B1-B22, or any other method or process described herein.

Example Z04 may include a method, technique, or process as described in or related to any of examples A1-A20, B1-B22, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A20, B1-B22, or portions thereof.

Example Z06 may include a signal as described in or related to any of examples A1-A20, B1-B22, or portions or parts thereof.

Example Z07 may include a datagram, packet, frame, segment, protocol data unit (PDU), or message as described in or related to any of examples A1-A20, B1-B22, or portions or parts thereof, or otherwise described in the present disclosure.

Example Z08 may include a signal encoded with data as described in or related to any of examples A1-A20, B1-B22, or portions or parts thereof, or otherwise described in the present disclosure.

Example Z09 may include a signal encoded with a datagram, packet, frame, segment, protocol data unit (PDU), or message as described in or related to any of examples A1-A20, B1-B22, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A20, B1-B22, or portions thereof.

Example Z11 may include a computer program comprising instructions, wherein execution of the program by a processing element is to cause the processing element to carry out the method, techniques, or process as described in or related to any of examples A1-A20, B1-B22, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMATime Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-20. (canceled)

21. One or more non-transitory computer-readable media (NTCRM) having instructions, stored thereon, that when executed by one or more processors of a reduced capability (RedCap) user equipment (UE), configure the UE to:
determine a timeline requirement for the RedCap UE associated with a random access procedure, wherein the timeline requirement is longer than for non-RedCap UEs; and
perform the random access procedure based on the timeline requirement.

22. The one or more NTCRM of claim 21, wherein to perform the random access procedure includes to retransmit a physical random access channel (PRACH) in accordance with the timeline requirement.

23. The one or more NTCRM of claim 22, wherein the instructions, when executed, further configure the RedCap UE to:
perform an initial transmission of the PRACH; and
receive a random access response (RAR) physical downlink shared channel (PDSCH);
wherein the timeline requirement corresponds to a time period between reception of the RAR PDSCH and the retransmission of the PRACH.

24. The one or more NTCRM of claim 23, wherein the retransmission of the PRACH is performed if the RedCap UE does not correctly receive a transport block of the RAR PDSCH.

25. The one or more NTCRM of claim 23, wherein the retransmission of the PRACH is performed if a RAPID of the RAR PDSCH is not associated with the initial transmission of the PRACH.

26. The one or more NTCRM of claim 21, wherein the timeline requirement corresponds to a minimum time period between reception of a fallback random access response (RAR) and transmission of a Msg3 by the RedCap UE.

27. The one or more NTCRM of claim 26, wherein the time period is equal to N_{T,1}+N_{T,2}+0.5+X milliseconds, wherein:
N_{T,1} is a time duration of N₁ symbols corresponding to a PDSCH processing time for UE processing capability 1 when an additional PDSCH demodulation reference signal (DM-RS) is configured;
N_{T,2} is a time duration of N₂ symbols corresponding to a physical uplink shared channel (PUSCH) preparation time for UE processing capability 1; and
X is an additional time allocation for RedCap UEs.

28. The one or more NTCRM of claim 21, wherein the timeline requirement corresponds to a time period between a success random access response (RAR) and transmission of a corresponding hybrid automatic repeat request (HARQ)-acknowledgement (ACK) by the RedCap UE.

29. The one or more NTCRM of claim 21, wherein the timeline requirement is 1 slot for a Msg2 physical downlink shared channel (PDSCH) larger than 25 physical resource blocks (PRBs) for a subcarrier spacing (SCS) of 15 kilohertz (kHz) or larger than 12 PRBs for a SCS of 30 kHz.

30. One or more non-transitory computer-readable media (NTCRM) having instructions, stored thereon, that when executed by one or more processors of a next generation Node B (gNB), configure the gNB to:
determine a timeline requirement for RedCap UEs associated with a random access procedure, wherein the timeline requirement is longer than for non-RedCap UEs; and
perform the random access procedure with a first RedCap UE based on the timeline requirement.

31. The one or more NTCRM of claim 30, wherein to perform the random access procedure includes to receive a retransmission of a physical random access channel (PRACH) in accordance with the timeline requirement.

32. The one or more NTCRM of claim 31, wherein the instructions, when executed, further configure the gNB to:
transmit a random access response (RAR) physical downlink shared channel (PDSCH) to the RedCap UE, wherein the timeline requirement corresponds to a time period between reception of the RAR PDSCH by the RedCap UE and the retransmission of the PRACH.

33. The one or more NTCRM of claim 32, wherein the retransmission of the PRACH is performed if the RedCap UE does not correctly receive a transport block of the RAR PDSCH or if a RAPID of the RAR PDSCH is not associated with the initial transmission of the PRACH.

34. The one or more NTCRM of claim 30, wherein the timeline requirement corresponds to a minimum time period between reception of a fallback random access response (RAR) by the RedCap UE and transmission of a Msg3 by the RedCap UE.

35. The one or more NTCRM of claim 34, wherein the time period is equal to N_{T,1}+N_{T,2}+0.5+X milliseconds, wherein:
N_{T,1} is a time duration of N₁ symbols corresponding to a PDSCH processing time for UE processing capability 1 when an additional PDSCH demodulation reference signal (DM-RS) is configured;
N_{T,2} is a time duration of N₂ symbols corresponding to a physical uplink shared channel (PUSCH) preparation time for UE processing capability 1; and
X is an additional time allocation for RedCap UEs.

36. The one or more NTCRM of claim 30, wherein the timeline requirement corresponds to a time period between a success random access response (RAR) and transmission of a corresponding hybrid automatic repeat request (HARQ)-acknowledgement (ACK) by the RedCap UE.

37. The one or more NTCRM of claim 30, wherein the timeline requirement is 1 slot for a Msg2 physical downlink shared channel (PDSCH) larger than 25 physical resource blocks (PRBs) for a subcarrier spacing (SCS) of 15 kilohertz (kHz) or larger than 12 PRBs for a SCS of 30 kHz.

38. An apparatus to be implemented in a reduced capability (RedCap) user equipment (UE), the apparatus comprising:
a memory to store an indication of a timeline requirement associated with a random access procedure, wherein the timeline requirement is longer than for non-RedCap UEs; and
processor circuitry coupled to the memory, wherein, to perform the random access procedure, the processor circuitry is to:
encode, for transmission to a next generation Node B (gNB), a physical random access channel (PRACH);
receive a random access response (RAR) physical downlink shared channel (PDSCH); and
encode a subsequent message for transmission based on the timeline requirement, wherein the timeline requirement corresponds to a time period between the reception of the RAR PDSCH and the transmission of the subsequent message.

39. The apparatus of claim 38, wherein the subsequent message is a Msg3 or a retransmission of the PRACH.

40. The apparatus of claim 38, wherein the time period is equal to N_{T,1}+N_{T,2}+0.5+X milliseconds, wherein:
N_{T,1} is a time duration of N₁ symbols corresponding to a PDSCH processing time for UE processing capability 1 when an additional PDSCH demodulation reference signal (DM-RS) is configured;
N_{T,2} is a time duration of N₂ symbols corresponding to a physical uplink shared channel (PUSCH) preparation time for UE processing capability 1; and
X is an additional time allocation for RedCap UEs.
